(19) United States
(12) Patent Application Publication
(10) Pub. No.: US 2002/0136479 A1
(43) Pub. Date: Sep. 26, 2002

(54) Tunable pulse width optical pulse generator

(76) Inventors: Simon Verghese, Arlington, MA (US); Michael J. LaGasse, Lexington, MA (US)

Correspondence Address: Elizabeth E. Kim, McDermott, Will & Emery, 28 State Street, Boston, MA, 02109, US

(21) Appl. No.: 10/078,888

(22) Filed: Feb. 19, 2002

Related U.S. Application Data
(60) Provisional application No. 60/270,016, filed on Feb. 20, 2001.

(51) Int. Cl. G02F 1/035; G02F 1/03

(52) U.S. Cl. 385/2; 359/245

(57) ABSTRACT

A system for generating variable pulse width optical pulses includes an optical modulator, and means for generating an electrical modulation signal. The optical modulator includes an optical input for receiving an input optical signal, a modulation input for receiving the electrical modulation signal that modulates the input optical signal, and an optical output for providing output optical pulses resulting from the modulation of the input optical signal. The electrical modulation signal is formed by combining a base waveform with one or more odd harmonics of the base waveform. The pulse widths of the output optical pulses can be precisely controlled, by adjusting the relative amplitudes and phases of each of the constituent waveforms that form the modulation signal. The system can be used as part of a variable transmission window OTDM demultiplexer.

### CROSS-REFERENCE TO RELATED APPLICATIONS

This application claims right of priority based on U.S. Provisional Application Serial No. 60/270,016, filed on Feb. 20, 2001.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention relates to optical pulse generators, and in particular, to a system and method for generating return-to-zero (RZ) optical pulses of variable pulse width.

### BACKGROUND

In the modern networking industry, there is a tremendous demand for bandwidth. Optical fibers can provide the necessary bandwidth, if the available bandwidth is tapped through appropriate techniques. One technique for accessing the bandwidth available in optical fibers is Dense Wavelength Division Multiplexing (DWDM). Using DWDM, network providers can send many signals on one fiber, just as though each signal were traveling on its own fiber, by transmitting each signal at a different frequency. DWDM networks encounter, however, a number of problems, for example system degradation arising from fiber nonlinearities.

Another approach for accessing the available bandwidth of optical fibers in high-speed networking applications is time-division multiplexing in all-optical networks, i.e. optical time-division multiplexing (OTDM). In OTDM networks, many different signals are sent through a single optical fiber, each signal distinguished from one another by different time slots. In other words, different nodes within an OTDM network get different time slots to transmit their data.

For high-speed OTDM transmission, very narrow optical pulses, with high repetition rates, must be generated. Narrow optical pulses are pulses that occupy very small intervals of time, or equivalently, optical pulses that have a steep intensity change produced by a control signal. Optical pulses must be narrow for OTDM transmissions, because in OTDM a single clock pulse is split into multiple sub-channels, depending on the ratio by which the data transmission rate of a single channel is to be increased through optical multiplexing.

In OTDM, optical pulses in all the multiple sub-channels are modulated in parallel, by separate data streams. The resulting outputs from the multiple sub-channels are then combined together, generating an optically multiplexed OTDM signal. The original clock pulses must thus be narrow enough so as to avoid overlapping within a single, multiplexed channel. For example, an OTDM network having 10 nodes, each of which generates data at 10 Gb (gigabits)/sec, would require a composite optical transmission of 100 Gb /sec. This implies a bit interval of about 10 picoseconds, i.e. pulsewidths of approximately 5 picoseconds for RZ (return-to-zero) optical pulses. For state-of-the-art high bandwidth optical communications networks, it is desirable that optical pulses be narrow enough to fit into a single channel having a bandwidth of at least 40 Gb/sec or higher.

At high data rates, it is difficult to generate narrow optical pulses with prior art pulse generators, especially for very long distance propagation. Prior art approaches to generating optical pulses include the use of gain-switched semiconductor lasers, and the use of mode-locked lasers. In gain-switched lasers, a distributed feedback (DFB) laser is directly driven with high-quality electrical sinusoidal waveforms, producing narrow optical pulses at repetition rates of Gb per second. Mode-locked lasers may be external-cavity semiconductor lasers which are driven with a single frequency RF signal. The length of the laser cavity is adjusted so that the optical round-trip time is a multiple of the period of the RF drive signal. The resulting output is a train of short optical pulses at a high repetition rate.

These prior art methods suffer from a number of disadvantages. For example, optical pulse trains produced by gain switching tend to be highly chirped, and may be characterized by large timing jitter. Also, it is difficult to control the optical pulse characteristics, such as pulse width, spectrum, and extinction ratio, over a desired range of operating conditions, when these prior art methods are used.

Accordingly, in modern optical communications systems there is a need for creating optical pulses of controllable pulse width, which can easily be optimized for a given set of propagation impairments. In particular, it is desirable to provide a system and method for generating, with relative ease of implementation, narrow optical pulses with precisely controllable pulse width, pulse spectrum, and other pulse characteristics, over a wide range of operating conditions.

U.S. patent application Ser. No. 09/973,873 (the “'873 application”), entitled “Variable Pulse Width Optical Pulse Generation With Superposed Multiple Frequency Drive,” commonly owned by the assignee of the present invention and hereby incorporated by reference, discloses a system and method for generating optical pulses having narrow pulse widths and high extinction ratios, by driving a pair of cascaded interferometric modulators with drive signals that include multi-frequency waveforms.

A single stage interferometric modulator offers several advantages, compared to a system of cascaded interferometric modulators, when generating optical pulses. For example, a single stage interferometric modulator requires fewer parts, and is thus more reliable and less costly, as compared to a cascaded system of interferometric modulators arranged in a first and a second stage. Also, a single stage interferometric modulator entails lower optical loss, as compared to a multi-stage interferometric modulator. It is therefore desirable to provide a system and method for generating narrow optical pulses having a controllable pulse width, using a single stage optical modulator.

### SUMMARY OF THE INVENTION

The present invention relates to a variable pulse width optical pulse generation system and method. A principal discovery of the present invention is that optical pulses having precisely controllable pulse widths can be generated by driving the modulation input of a single optical modulator with an electric modulation signal that is formed by combining a signal at a base frequency f₁, with one or more odd harmonics of that base frequency f₁.

The present invention features an optical pulse generator that includes an optical modulator. The optical modulator may be an electro-optic interferometric modulator, such as a Mach-Zehnder modulator, or an electro-absorption modulator. The optical modulator includes an optical input for receiving an input optical signal, a modulation input for receiving an electric modulation signal that modulates the input optical signal, and an optical output for providing output optical pulses that result from the modulation. The electric modulation signal is formed by superposing a plurality of waveforms having different frequencies. The relative amplitudes and phases of each of the plurality of waveforms can be adjusted, so as to achieve a desired pulse width for the output optical pulses.

In a preferred embodiment of the invention, the superposition of waveforms is formed by combining a base waveform characterized by a base frequency f₁, and one or more odd harmonics of the base waveform, i.e. waveforms that are characterized by frequencies F₂ₙ₊₁ that are related to the base frequency fi according to the formula:

f₂ₙ₊₁=(2n+1)*f₁,

where n is an integer (n=0, 1, 2, . . . ).

The optical pulse generator of the present invention preferably includes means for generating the electric modulation signal, i.e. a modulation source. In one form of the invention, the modulation source includes an amplifier having an input for receiving a first electric signal having a base frequency f₁. The amplifier is adapted to amplify the first electric signal, and to distort the first electric signal by an amount sufficient to generate a second electric signal whose frequency is an odd harmonic of f₁.

In another form of the invention, the modulation source includes a combiner, for example a frequency diplexer. The combiner has a first input for receiving a first electric input signal having a base frequency f₁, and a second input for receiving a second electric input signal whose frequency is an odd harmonic of f₁. The combiner also has an output for providing an electric output signal that is a combination of the first electric input signal and the second electric input signal.

In another form of the invention, the modulation source includes an input for receiving a first electric signal having a base frequency f₁, and a splitter for splitting the first electric signal into at least a first component and a second component. The modulation source further includes an amplifier for amplifying the first component, so as to produce a first amplified signal, and a frequency multiplier. The frequency multiplier receives the second component, and produces a second electric signal whose frequency is an odd harmonic of f₁. The modulation source further includes a variable gain amplifier that amplifies the second electric signal, so as to provide a second amplified signal. The modulation source further includes a combiner for combining the first amplified signal and the second amplified signal, so as to generate the electric modulation signal.

The present invention features a method of generating optical pulses with a variable pulse width. The method includes receiving an input optical signal at an optical input of an optical modulator, and generating an electric modulation signal by superposing a plurality of waveforms, wherein each waveform is characterized by different frequencies. The method includes modulating the input optical signal by applying the electric modulation signal to a modulation input of the optical modulator, so as to generate output optical pulses. The method includes adjusting the relative amplitudes and phases of each of the plurality of waveforms, in order to achieve a predetermined pulse width for the output optical pulses.

The system and method of the present invention can also be used in a variable transmission window OTDM demultiplexer. In one embodiment, the present invention features an OTDM demultiplexer which includes an optical modulator. The optical modulator has an optical input for receiving an input optical signal that includes encoded data. The input optical signal is modulated with an electric modulation signal that is formed by combining a base waveform with one or more odd harmonics of the base waveform. The relative amplitudes and phases of the waveforms that constitute the modulation signal are varied, thereby varying the transmission window of the OTDM demultiplexer.

### BRIEF DESCRIPTION OF THE DRAWINGS

The invention can be more fully understood by referring to the following detailed description taken in conjunction with the accompanying drawings, in which:

FIG. 1 illustrates a schematic block diagram of one embodiment of an optical pulse generator, constructed in accordance with the present invention.

FIG. 2A illustrates a Mach-Zehnder type wide band modulator, as used in the prior art.

FIG. 2B illustrates the electrode structure for a narrow band interferometric modulator, as used in the prior art.

FIG. 3A illustrates the electrode structure for a narrow band interferometric modulator, adapted for use in an optical pulse generator constructed in accordance with one embodiment of the present invention.

FIG. 3B illustrates an exemplary physical layout of the electrode structure for the modulator depicted in FIG. 3A.

FIG. 4A illustrates a schematic block diagram of the electrode structure for a modulation source for generating a modulation drive signal, in accordance with one embodiment of the present invention.

FIG. 4B illustrates a schematic block diagram of the electrode structure for a modulation source for generating a modulation drive signal, in accordance with another embodiment of the present invention.

FIG. 4C illustrates a schematic block diagram of the electrode structure a modulation source for generating a modulation drive signal, in accordance with another embodiment of the present invention.

FIG. 5 is a schematic plot which illustrates the results of numerical calculations that quantify the variation in pulse width that is achievable when the amount of the signal amplitude at 3f₁=30 GHz is adjusted, relative to the amount of the signal amplitude at f₁=10 GHz.

FIG. 6 illustrates the experimentally measured data for the pulse width of the output optical pulses generated by an optical pulse generator, constructed in accordance with one embodiment of the present invention, when the 30 GHz frequency component of the modulation drive signal is about 15 dB weaker than the 10 GHz frequency component.

FIG. 7 illustrates the experimentally measured data for the pulse width of the output optical pulses generated by an optical pulse generator, constructed in accordance with one embodiment of the present invention, when the 30 GHz component of the modulation drive signal is more than 40 dB weaker, as compared to the 10 GHz component.

### DETAILED DESCRIPTION

The present invention is directed to a system and method for generating RZ optical pulses having variable and precisely controllable pulse width. In the present invention, an optical modulator is driven with an electric modulation signal, which is formed by combining a first RF signal at a base frequency f₁ with one or more RF signals that are odd harmonics of f₁, i.e. related to f₁ by the formula f₂n+1=(2n+1)*f₁, where n is an integer. The temporal width of the RZ optical pulses can thus be continuously adjusted, by changing the relative amplitudes and phases of the individual frequencies that form the modulation signal.

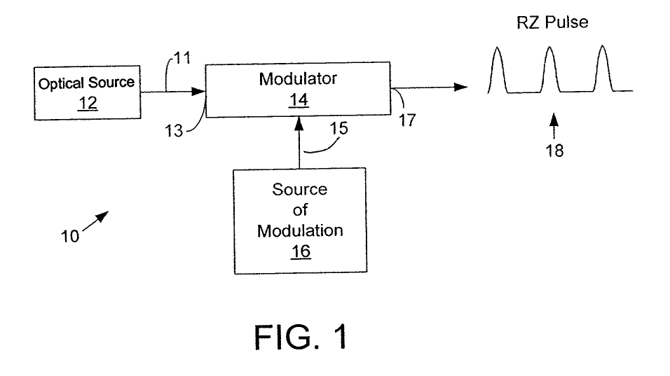

FIG. 1 illustrates a schematic block diagram of one embodiment of a system 10 for generating variable pulse width optical pulses, in accordance with the present invention. The system 10 includes an optical source 12 that generates an optical output. In the illustrated embodiment, in which the system 10 is used to generate a periodic pulse train, the optical output is a continuous-wave signal. In other embodiments of the invention, for example when the system 10 is used as part of an OTDM demultiplexer, the optical output of the optical source 12 may be a modulated optical signal, for example an optical signal that is modulated with non-return-to-zero (NRZ) data or by optical phase modulation.

The optical output of the optical source 12 forms an input optical signal 11 that is received at an optical input 13 of an optical modulator 14. The input optical signal 11 is modulated by the optical modulator 14, by means of an electric modulation signal 15. A modulation source 16 generates the modulation signal 15 by combining a plurality of harmonically related frequency components. The result of the modulation is a series of output RZ pulses 18, which are generated from an optical output 17 of the optical modulator 14.

In a preferred embodiment of the invention, the modulator 14 is an electro-optic interferometric modulator. As well known, an electro-optic interferometric modulator is made of a material whose refractive index can be altered through an applied electric field. The change in refractive index causes a change in the phase of a light wave passing through the material. Monochromatic light from a laser is received at an input of an electro-optic interferometric modulator, and split into two equal beams that are respectively transmitted along two different paths. By applying an electric field to each of these paths, the phases of the two waves can be shifted relative to each other.

In other embodiments of the invention, optical modulators other than an interferometric modulator can also be used. For example, the modulator may be an electro-absorption modulator. Electro-absorption modulators (EAM) can be made of materials similar to semiconductor lasers, and can therefore be integrated with a transmission laser in a small package. In order to prevent light from passing through an EAM, a high reverse bias is applied, thereby absorbing light and preventing light from passing through. In order to allow light to pass through the EAM, no current or a forward bias is applied to the modulator, so that the modulator becomes transparent to light. EAMs can therefore be used to absorb or transmit light, as desired, so as to generate a data stream of 1s and 0s.

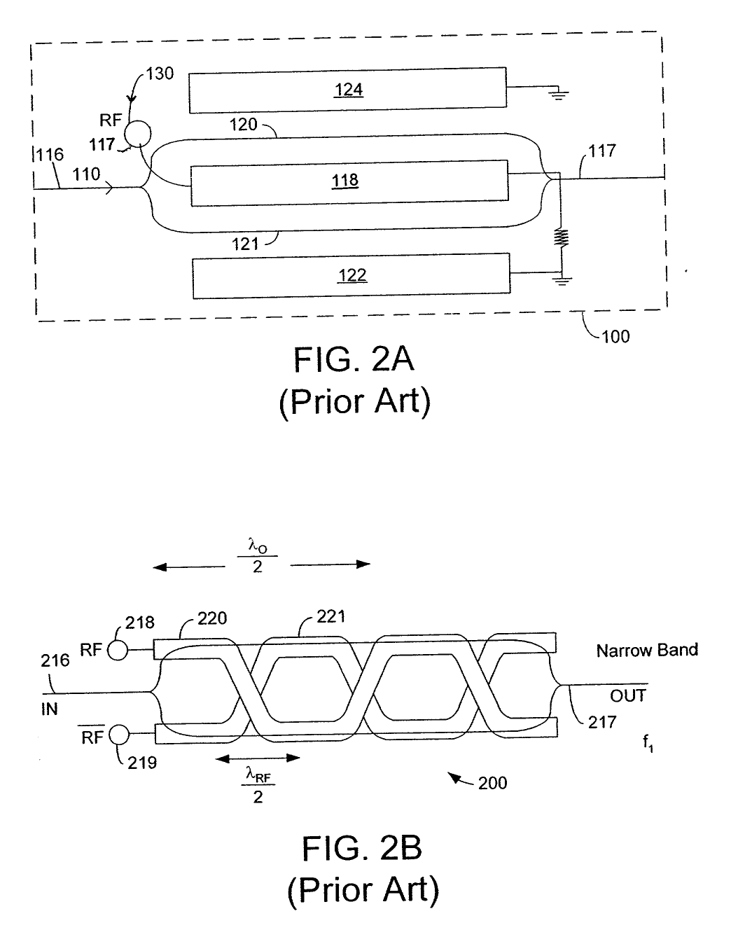

FIG. 2A illustrates a prior art electro-optic interferometric modulator 100, having a Mach-Zehnder configuration. Most prior art Mach-Zehnder modulators, including the modulator 100 shown in FIG. 2A, are designed for wide RF bandwidth, i.e. are not restricted to be used in a narrow band of frequencies. Mach-Zehnder modulators may be constructed out of materials such as polymers, lithium niobate (LiNbO₃), indium phosphide (InP), or gallium arsenide (GaAs); however, lithium niobate is most widely selected as the material of choice for the fabrication of electro-optic modulators. Because of its combination of high electro-optic coefficients, and high optical transparency in the near infrared wavelengths that are used in telecommunications, lithium niobate provides an efficient means of achieving optical modulation. Lithium niobate is also thermally, chemically, and mechanically stable, and is compatible with conventional integrated-circuit processing technology.

As shown in FIG. 2A, an optical signal 110 is provided at an input end 116 of the prior art Mach-Zehnder modulator 100. The signal 110 is then split along a first waveguide branch 120 and a second waveguide branch 121, respectively. The first waveguide branch 120 and the second waveguide branch 121 are shown as parallel. A controlled, time-varying electric modulation signal 130 is typically applied to the first 120 and the second 121 waveguide branches, via an RF electrode 118 (having an input 117) and ground electrodes 122 and 124.

Because of the electro-optic effect, the index of refraction in each waveguide branch changes, in accordance with the changing amplitude of the modulating signal 130. The change in the refractive index alters the phase of the light in the waveguide region, resulting in a change in the delay time of the light passing through waveguide region. The optical path within the modulator 100 for the signal 110 is thus split into two paths, along the first 120 and the second 121 waveguide branches, respectively. The two paths have different optical path lengths, and thus the signals at the ends of the two optical paths are shifted in phase with respect to each other.

The two phase-shifted signals are recombined at an output end 117 of the prior art modulator 100. In order to transmit a signal consisting of 0s and 1s, by way of example, the phases of the two waves may be shifted relative to each other in such a way that the beams arrive at the far end either in phase to give a pulse of light, or half a wavelength out of phase, to give no light. The amount of phase shift introduced into each path is determined by the effect desired at the device output when the phase-shifted signals are recombined, and is accomplished by controlling the amplitude of the modulation signal 130. The optical transmission lines, depicted schematically in FIG. 2A, can be implemented in a number of ways, for example by selectively doping a substrate with a material that causes a change in the refractive index.

The prior art modulator 100 illustrated in FIG. 2A is a wide band modulator, in which the RF electrode 118 is velocity-matched to the optical waveguide. Typically, RF electrodes are fabricated either directly on the surface of the LiNbO₃ wafer, or on an optically transparent buffer layer so as to reduce optical loss due to metal loading and to provide a means for velocity matching. In the wide band modulator illustrated in FIG. 2A, the RF electrode 118 is velocity-matched onto the optical waveguide through the use of a thick buffer layer, and a thick electrode.

An optical clock stream of RZ pulses is most efficiently generated, however, by narrow band RF modulation, i.e. by using a modulator whose modulation bandwidth is substantially limited to a narrow range of frequencies. A narrow-band modulator has a lower V_{π} for a given physical length, as compared to a wide band modulator, where V_{π} represents the voltage required to change the optical output power from the modulator from a minimum value to a maximum value. Lowering V_{π} dramatically eases the RF power requirements for an optical pulse generator, both for generating modulating signals at the base frequency f₁, or at odd harmonics of the base frequency f₁.

The electro-optic efficiency at modulation frequency can be improved, at the expense of the modulation bandwidth, by using RF phase-matching techniques such as phase reversal. Such narrow band techniques allow the buffer/electrode structure to be optimized for the best field overlap. RF phase matching can be achieved by periodically flipping the polarity of the electro-optic interaction, by way of example.

FIG. 2B schematically illustrates a narrow band modulator 200, as used in the prior art. The narrow band modulator 200 includes a first RF electrode 220, having a first input 218, and a second RF electrode 221, having a second input 219. In the narrow band modulator 200, the RF electrodes 220 and 221 are periodically switched, thereby causing a phase reversal. Due to the electrode switching, the walk-off between the RF and the optical waves is reduced.

In the illustrated modulator 200, the optical wavelength λ₀=V_{g}/f₁ is approximately twice as long as the RF wavelength λ_{RF}, where v_{g} stands for the group velocity of the optical wave, and f₁ represents the base frequency of the output optical pulses. The optical wave velocity in the modulator is a function of the properties of the materials forming the modulator, and of the cross-sectional dimensions of the waveguide. The narrow band modulator 200 has a relatively high modal overlap between the RF and the optical waves, because the narrow band modulator 200 does not require a thick buffer layer and, therefore, is relatively efficient and has a relatively low V_{π}.

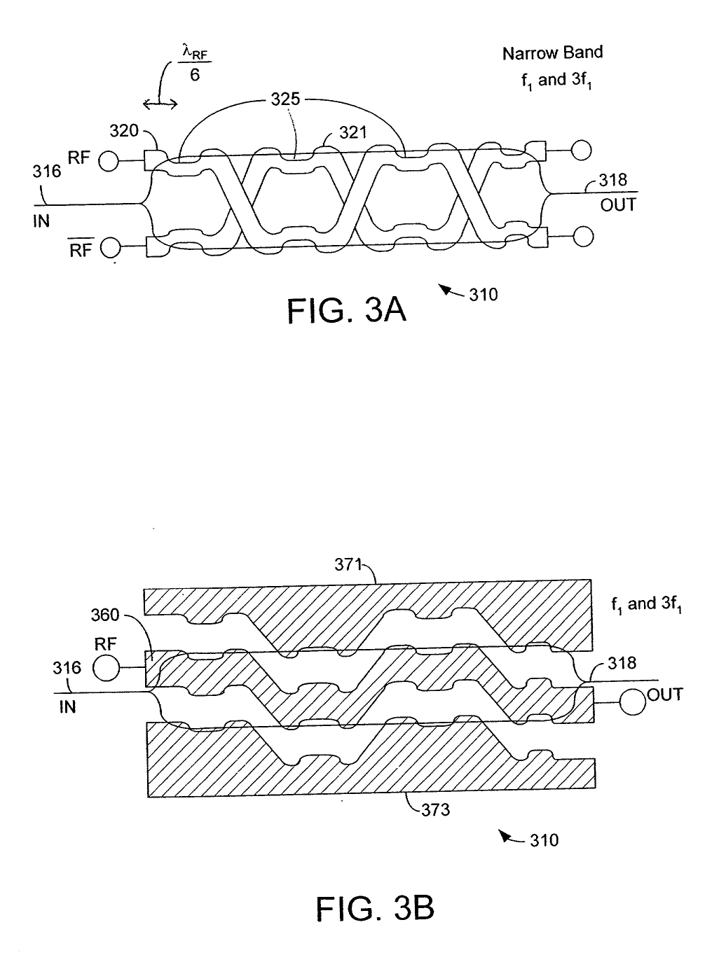

FIG. 3A illustrates a narrow band interferometric modulator 310, adapted for use in an optical pulse generator, constructed in accordance with one embodiment of the present invention. In this embodiment, an input optical signal is modulated using a modulation signal that is a combination of a base frequency f₁ and an odd harmonic f₃ of the base frequency. The modulator 310 includes an input end 316 for receiving an input optical signal, and an output end 318 for providing output optical pulses. The modulator 310 receives an electric modulation signal through a modulation input, which includes a first RF electrode 320 and a second RF electrode 321. As in the prior art modulator 200 shown in FIG. 2B, the RF electrodes 320 and 321 are also periodically switched. Unlike the prior art device shown in FIG. 2B, however, the RF electrodes 320 and 321 are diverted off of the optical waveguide in small sections 325 between the electrode switchings.

The performance of the modulator 310 at the base frequency f₁ is similar to that of the modulator 200 depicted in FIG. 2B, since the electrode diversions 325 can be made sufficiently small so as to only have a small effect on the f₁ wave. The performance of the modulator 310 at the frequency f₃=3×f₁ is enhanced, if each electrode diversion 325 is positioned substantially where the signal at 3×f₁ is approximately 180 degrees out-of-phase for velocity matching. In this way, the amount of walk-off is minimized at 3×f₁, and the efficiency at 3×f₁ is maximized.

FIG. 3B illustrates an exemplary physical layout of the modulator 310 depicted in FIG. 3A. Typically, LiNbO₃ wafers are available in different crystal cuts (x-cut or z-cut, by way of example), which relate to the orientation of the crystal axes relative to the waveguides and electrodes. The crystal cut affects both modulator efficiency, as denoted by the half-wave voltage V_{π}, as well as the modulator chirp.

In the embodiment illustrated in FIG. 3B, the modulator 310 is made from z-cut LiNbO₃. For a z-cut configuration, the RF electrodes are placed on top of the LiNbO₃ waveguide (in contrast to x-cut devices in which the waveguide is placed between the electrodes). Because the electrodes are placed on top of the waveguides, z-cut devices always require a buffer layer, to minimize attenuation of the optical mode due to metal absorption. FIG. 3B illustrates a coplanar waveguide implementation, in which the RF modulation signal is applied to a conductor 360, and the RF signal's reference is applied to the conductive planes 371 and 373.

The modulator 310 illustrated in FIGS. 3A and 3B is optimized to function at two harmonically related frequencies (f₁ and 3×f₁), simultaneously. The modulator 310 can simultaneously lower V_{π} at f₁ and 3×f₁, and greatly reduce the size and power of the RF hardware needed to implement the modulation source that generates the modulation signal.

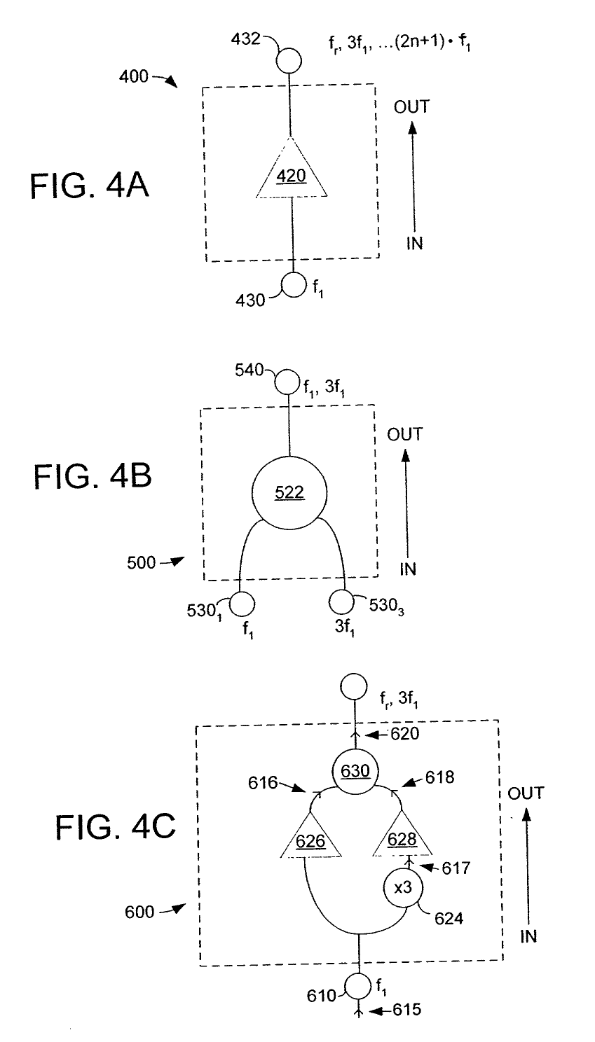

FIG. 4A illustrates a schematic block diagram of one embodiment of the electrode structure for a modulation source 400 for generating a modulation drive signal that is a combination of harmonically related frequencies. The modulation source 400 includes an amplifier 420. The amplifier 420 has a predefined distortion characteristic, and includes an amplifier input 430 and an amplifier output 432. The amplifier 420 receives at the input 430 an RF input signal at a base frequency f₁. The amplifier 420 simultaneously amplifies the input signal, and introduces a distortion of the f₁ signal that is sufficient to generate RF signals at frequencies f₃, f₅, . . . , f₍₂ₙ₊₁₎, where

f₍₂ₙ₊₁₎=(2n+1)*f₁, n=1, 2, . . .

The amplifier output 432 provides an electric modulation signal, which is a superposition of the plurality of frequencies f₁, f₃, . . . , f₍₂ₙ₊₁₎. By adjusting the relative amplitudes and phases of each of the frequency components, a desired pulse width can be achieved for the output optical pulses.

FIG. 4B illustrates a schematic block diagram of another embodiment of the electrode structure for a modulation source 500 for generating a modulation drive signal that includes a combination of harmonically related frequencies, in accordance with another embodiment of the present invention. The modulation source 500 includes a combiner 522. By way of example, the combiner 522 may be a passive frequency diplexer, and can be of the type described in U.S. patent application Ser. No._____, attorney docket number PTX-010, entitled “High-Frequency Diplexer,” filed on Feb. 19, 2002, and assigned to the current assignee. The entire disclosure of this U.S. patent application is incorporated herein by reference. The combiner 522 has one output 540, and may have a plurality of inputs, for example inputs 5301, 530₃ . . . 530₍₂ₙ₊₁₎, (n=0, 1, 2, . . . ).

In the embodiment illustrated in FIG. 4B, an input signal at frequency f₁, together with another input signal that is a first odd harmonic f₃=3×f₁, are provided at the inputs 530₁ and 530₃. The combiner 522 combines the base frequency component f₁ with its first odd harmonic f₃, to generate an output signal which is a superposition of the frequency components f₁ and f₃. The output signal at the output 540 of the combiner 522 is provided to the electrical modulation input of the modulator. The modulator uses the output electrical signal as a modulation signal to modulate the input optical signal.

FIG. 4C illustrates a schematic block diagram of yet another embodiment of the electrode structure for a modulation source 600 for generating a modulation drive signal that includes a combination of harmonically related frequencies. The modulation source 600 includes an input 610 for receiving a first electric signal 615 having a base frequency f₁, and a splitter for splitting the first electric signal 615 into at least a first component and a second component, both at frequency f₁. The modulation source 600 further includes an amplifier 626, and a frequency multiplier 624. The amplifier 626 amplifies the first component, so as to produce a first amplified signal 616. The second component is applied to the frequency multiplier 624, which produces a second electric signal 617 at a frequency that is a multiple of f₁.

In the embodiment illustrated in FIG. 4C, the multiplier 624 triples the frequency f₁, so that the second electrical signal 617 has a frequency f₃=3×f₁. The modulation source 600 further includes a variable-gain automatic gain controlled (AGC) amplifier 628. The variable gain amplifier 628 amplifies the second electric signal, so as to provide a second amplified signal 618.

In an alternative embodiment (not illustrated), the AGC amplifier 628 may be positioned before the frequency multiplier 624, so that the second component of the first electric signal 615 is amplified, before being applied to the frequency multiplier 624. In this embodiment, the frequency multiplier 624 multiplies the frequency of the amplified second component of the first signal 615, producing the amplified second electrical signal 618.

The modulation source 600 further includes a combiner 630. The combiner 630 combines the first amplified signal 616 and the second amplified signal 618, so as to generate an output electrical signal 620, which is a combination of frequency components at f₁ and at f₃3×f₁. The output electrical signal 620 is provided to the electrical modulation input of the modulator, which uses the output electrical signal 620 to modulate input optical signals.

In operation, an input optical signal is received from a continuous wavelength laser into an optical input of an optical modulator. A modulation source generates an electric modulation signal by combining a plurality of frequency components, including a base frequency f₁, and odd harmonics thereof. The electric modulation signal is applied to an modulation input of the optical modulator, so as to modulate the input optical signal. The resulting output signal from the modulator consists of tunable pulse width optical pulses.

By varying the amplitudes and phases of the individual frequency components that form the electric modulation signal, the pulse width of the output optical pulses can be adjusted. In particular, the relative amplitudes and phases of the individual frequency components that form the electric modulation signal can be adjusted to values that substantially minimize the pulse width of the output optical pulses.

The system and method of the present invention can also be used for a variable pulse width OTDM demultiplexer (not shown), i.e. an OTDM demultiplexer having a variable transmission window. At an output (or receiver end) of an OTDM network, the lower bit-rate data streams must be extracted from an optically multiplexed signal, i.e. from the high bit-rate data stream that was constructed at an input of the OTDM network by optical time-division multiplexing a plurality of lower bit-rate data streams.

A variable transmission window OTDM demultiplexer, constructed in accordance with one embodiment of the present invention, includes an optical modulator, for example an electro-absorption modulator. The modulator has an optical input for receiving an input optical signal that includes encoded data. The encoded data typically come from a fiber link, and may be RZ encoded data, or NRZ encoded data. The modulator further includes an electric modulation input for receiving an electric modulation signal, formed by superposing a base waveform characterized by a base frequency f₁, and one or more odd harmonics having frequencies f₂ₙ₊₁=(2n+1)*f₁. The electric modulation signal modulates the input optical signal that includes encoded data. By varying the relative amplitudes and phases of the waveforms that form the electric modulation signal, the transmission window of the OTDM demultiplexer can be varied as desired.

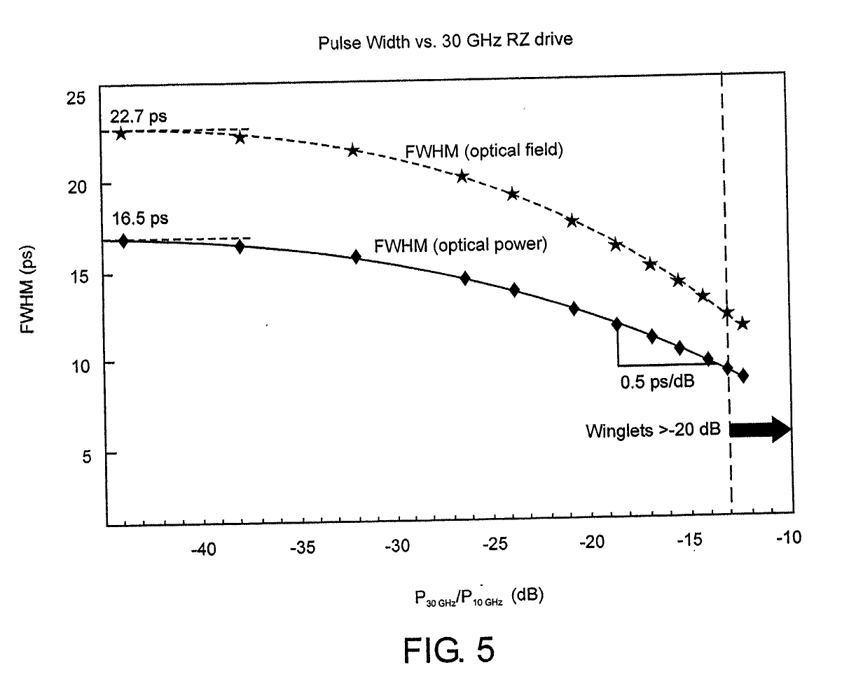

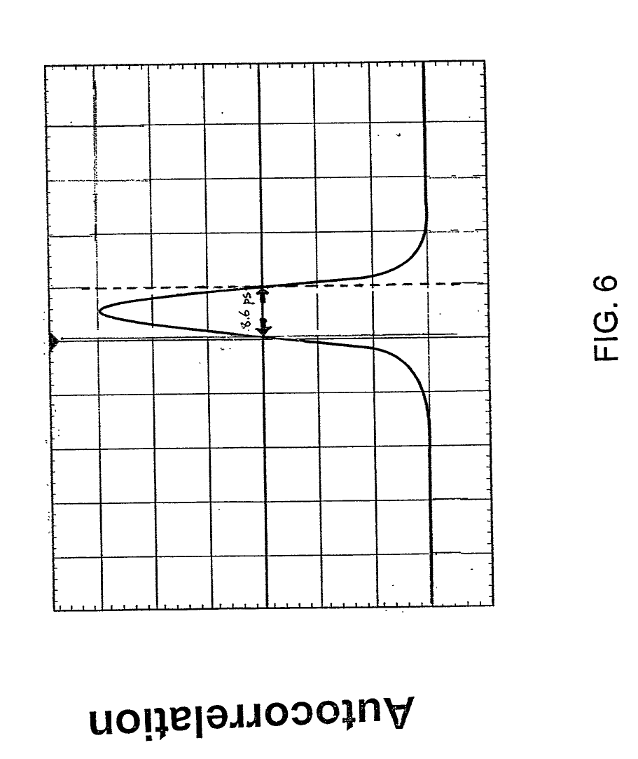

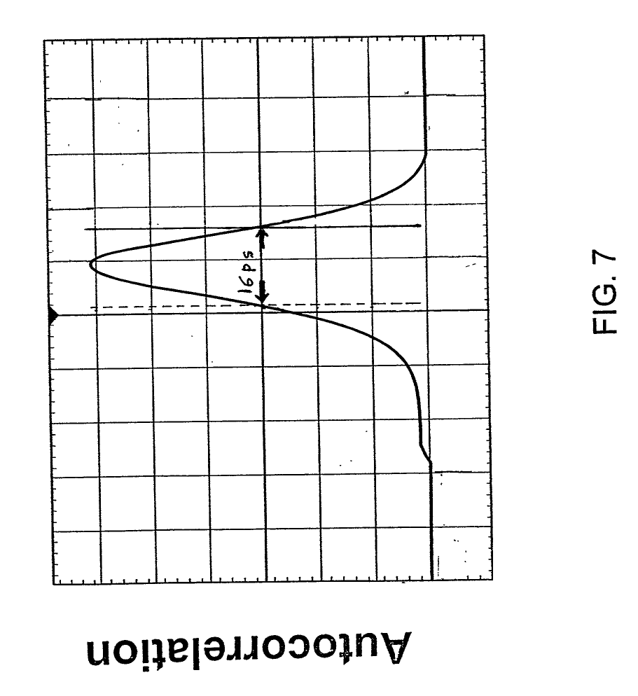

FIGS. 5-7 illustrate numerical calculations (FIG. 5) and experimentally measured data (FIGS. 6 and 7) that relate to optical pulse generation in accordance with the present invention. FIG. 5 is a schematic plot which illustrates the results of numerical calculations that quantify the variation in pulse width of a clock pulse train generated at f₁=10 GHz that is achievable when the amount of the signal amplitude at f₃=30 GHz is adjusted, relative to the amount of the signal amplitude at 10 GHz, in accordance with a pulse generation system and method of the present invention. In particular, the plot illustrates the results of simulated calculations of the pulse width of the output optical pulses, versus a ratio of the power of a 30 GHz frequency component to the power of a 10 GHz frequency component, when an input optical signal from a continuous wavelength laser is modulated with a modulation signal that is a superposition of a 10 GHz frequency component, and a 30 GHz frequency component.

As seen from FIG. 5, the usable range under the illustrated conditions is from about 8 ps to about 16.5 ps for the FWHM (full-width-at-half-maximum) in the output optical power. For very narrow pulses, less that 10 ps in FWHM of the output optical power, the ratio of the power of the 30 GHz frequency component to the 10 GHz frequency component should be approximately −17 dB.

FIG. 6 illustrates the experimentally measured data for the output pulse width of an optical pulse generator constructed in accordance with one embodiment of the present invention. In the illustrated embodiment, the measured output pulse width is about 8.6 ps. When compared with the simulated calculations of FIG. 5, the experimental measurements are in substantial agreement with theoretical calculations for the case in which the ratio of the power of a 30 GHz frequency component to the power of a 10 GHz frequency component is about −15 dB.

FIG. 7 illustrates the experimentally measured data for the pulse width of the output optical pulses generated by an optical pulse generator, constructed in accordance with one embodiment of the present invention. In the illustrated embodiment, the measured output pulse width is about 16 ps. Again, the experimental measurements are in good agreement for theoretical calculations for the case in which the 30 GHz component of the modulation drive signal is more than 40 dB weaker, as compared to the 10 GHz component.

In summary, the optical pulse generator of the present invention can be used to generate a stream of RZ pulses having a variable, easily controllable pulse width. The pulse width of the output optical pulses can be precisely controlled, with relative ease of implementation, by varying the relative strengths or amplitudes of the individual frequency components that form the modulation drive signal. The generated RZ pulse stream, of variable pulse width, can subsequently be encoded with digital data by a separate modulator. As bit rates move beyond 10 Gb/sec, optical pulse generating techniques such as the technique disclosed in the present invention will become necessary for achieving long-haul transmission distances. The system and method of the present invention can also be used as part of a variable transmission window OTDM demultiplexer, which can provide the flexibility necessary for optimizing receiver performance in OTDM networks.

What is claimed is:

1. An optical pulse generator, comprising:
an optical modulator, including:
a. an optical input for receiving an input optical signal,
b. a modulation input for receiving an electric modulation signal that modulates said input optical signal; and
c. an optical output for providing a modulated output optical signal comprising output optical pulses;
wherein said electric modulation signal comprises a superposition of a plurality of waveforms having different frequencies.

2. An optical pulse generator according to claim 1, wherein the relative amplitudes and phases of each of said plurality of waveforms are selected so that said output optical pulses are characterized by a predetermined pulse width.

3. An optical pulse generator according to claim 1, wherein said plurality of waveforms comprise sinusoidal waveforms.

4. An optical pulse generator according to claim 1, wherein said superposition of waveforms comprises:
i) a base waveform characterized by a base frequency f₁, and
ii) one or more odd harmonics of said base waveform, said odd harmonics being characterized by frequencies f₂ₙ₊₁ related to said base frequency f₁ according to the formula:
f₂ₙ₊₁=(2n+1)*f₁,
where n is an integer.

5. An optical pulse generator according to claim 1, wherein said optical modulator comprises an electro-optic interferometric modulator.

6. An optical pulse generator according to claim 5, wherein said interferometric modulator comprises a Mach-Zehnder modulator.

7. An optical pulse generator according to claim 5, wherein a substrate forming said interferometric modulator comprises a lithium niobate substrate.

8. An optical pulse generator according to claim 5, wherein said interferometric modulator is substantially velocity-matched.

9. An optical pulse generator according to claim 5, wherein said interferometric modulator has a bandwidth that is substantially limited to one or more predetermined bandwidths in order to increase an efficiency of the modulation of said input optical signal.

10. An optical pulse generator according to claim 1, wherein said optical modulator comprises an electro-absorption modulator.

11. An optical pulse generator according to claim 4, wherein said base frequency f₁ is from about 5 GHz to about 40 GHz.

12. An optical pulse generator according to claim 1, wherein said output optical pulses comprise RZ (return-to-zero) optical pulses.

13. An optical pulse generator according to claim 2, wherein said predetermined pulse width is between about 8 ps to about 16 ps.

14. An optical pulse generator according to claim 4, wherein said base frequency f₁ is 10.66 GHz, and wherein said output optical pulses are characterized by a repetition rate of about 21.32 GHz.

15. An optical pulse generator according to claim 1, further comprising means for generating said electric modulation signal.

16. An optical pulse generator according to claim 15, further comprising means for applying said electric modulation signal to said at least one modulation input.

17. An optical pulse generator according to claim 15, wherein said means for generating said electric modulation signal comprises an amplifier having an input for receiving a first electric signal having a base frequency f₁, said amplifier being adapted to amplify said first electric signal and to distort said first electric signal by an amount sufficient to generate a second electric signal characterized by a frequency f₂ₙ₊₁, wherein f₂ₙ₊₁ is an odd harmonic of f₁ and related to f₁ by the formula
f₂ₙ₊₁=(2n+1)*f₁,
where n is an integer.

18. An optical pulse generator according to claim 17, wherein said means for generating said electric modulation signal comprises a combiner, said combiner including:
a. a first input for receiving a first electric input signal characterized by a base frequency f₁;
b. a second input for receiving a second electric input signal characterized by a frequency f₂ₙ₊₁, wherein f₂ₙ₊₁ is an odd harmonic of f₁ and related to f₁ by the formula
f₂ₙ₊₁=(2n+1)*f₁,
and n is an integer; and
c. an output for providing an electric output signal that is a combination of said first electric input signal and said second electric input signal.

19. An optical pulse generator according to claim 18, wherein said combiner comprises a frequency diplexer.

20. An optical pulse generator according to claim 15, wherein said means for generating said electric modulation signal comprises:
a. an input for receiving a first electric signal characterized by a base frequency f₁;
b. a splitter for splitting said first electric signal into at least a first component and a second component;
c. a frequency multiplier that receives said second component of said first electric signal and produces a second electric signal characterized by a frequency f₂ₙ₊₁, wherein f₂ₙ₊₁ is an odd harmonic of f₁ and related to f₁ by the formula
f₂ₙ₊₁=(2n+1)*f₁,
and n is an integer; and
d. a combiner for combining said first component of said first electric signal and said second electric signal to produce said electric modulation signal.

21. An optical pulse generator according to claim 20, further comprising:
a. an amplifier for amplifying said first component of said first electric signal, thereby producing a first amplified signal; and
b. a variable gain amplifier that amplifies said second electric signal, thereby producing a second amplified signal;
wherein said combiner combines said first amplified signal and said second amplified signal to produce said electric modulation signal.

22. A method of generating optical pulses with a variable pulse width, the method comprising:
a) receiving an input optical signal at an optical input of an optical modulator;
b) generating a modulation drive signal by superposing at least a first waveform and a second waveform, wherein said first and said second waveforms are characterized by different frequencies;
c) modulating said input optical signal by applying said modulation drive signal to a modulation input of said optical modulator;
d) generating a modulated output optical signal comprising output optical pulses; and
e) adjusting the relative amplitudes and phases of said first and said second waveforms, so that the output optical pulses have a predetermined pulse width.

23. An OTDM (optical time-division multiplexed) demultiplexer, comprising:
A. an optical modulator, including:
a. an optical input for receiving an input optical signal including RZ (return-to-zero) encoded data;
b. a modulation input for receiving an electric modulation signal that modulates said input optical signal; and
c. an optical output for providing a modulated output optical signal comprising output optical pulses;
wherein said electric modulation signal comprises a superposition of a plurality of waveforms having different frequencies.

24. An OTDM demultiplexer according to claim 23, wherein the relative amplitudes and phases of each of said plurality of waveforms are selected so that said output optical pulses are characterized by a predetermined pulse width.

25. An OTDM demultiplexer according to claim 23, wherein said superposition of waveforms comprises:
i) a base waveform characterized by a base frequency f₁, and
ii) one or more odd harmonics of said base waveform, said odd harmonics being characterized by frequencies f₂ₙ₊₁ related to said base frequency f₁ according to the formula:
f₂ₙ₊₁=(2n+1)*f₁,
where n is an integer.

26. An OTDM demultiplexer according to claim 23, wherein said optical modulator is an electro-absorption modulator.
